(19) United States
(12) Patent Application Publication
(10) Pub. No.: US 2019/0158931 A1
(43) Pub. Date: May 23, 2019

(54) Set-Top Box with Enhanced Content and System and Method for Use of Same

(71) Applicant: Enseo, Inc., Richardson, TX (US)

(72) Inventors: Vanessa Ogle, Fairview, TX (US); William C. Fang, Plano, TX (US)

(21) Appl. No.: 16/194,587

(22) Filed: Nov. 19, 2018

Related U.S. Application Data
(60) Provisional application No. 62/587,795, filed on Nov. 17, 2017.

(51) Int. Cl. H04N 21/81; H04N 21/2668; H04N 21/458; H04N 21/234; H04N 21/432

(52) U.S. Cl. CPC H04N 21/812; H04N 21/2668; H04N 21/432; H04N 21/23424; H04N 21/458

(57) ABSTRACT

A set-top box with enhanced content and system and method for use of the same are disclosed. In one embodiment of the set-top box, a signal input, a signal output, a processor, and memory are communicatively interconnected within a busing architecture in a housing. The signal input is configured to receive a source signal which includes a stream of network programming having time slots interposed therein. The set-top box detects signaling data indicative of a designated time slot within the network programming and responsive thereto, interposes content stored at the set-top box at the designated time slot within the network programming. The set-top box then forwards the interposed content to the display via the signal output. Following the forwarding of the interposed content, the set-top box returns to receiving network programming on the signal input and forward the network programming to the display via the signal output.

### PRIORITY STATEMENT & CROSS-REFERENCE TO RELATED APPLICATIONS

This application claims priority from co-pending U.S. Patent Application Ser. No. 62/587,795 filed Nov. 17, 2017, in the name of William C. Fang; which is hereby incorporated by reference for all purposes.

### TECHNICAL FIELD OF THE INVENTION

This invention relates, in general, to set-top boxes and, in particular, to set-top boxes with enhanced content and systems and methods for use of the same that provide additional functionality to content providers and advertisers, for example.

### BACKGROUND OF THE INVENTION

Network programming on a television remains an effective advertising medium. To enhance effectiveness, advertisers seek to develop advertisements that target prospective consumers based on interests, behavior, demographics, or location, for example. A challenge that advertisers have with targeted advertising on traditional network programming on a television is being able to deliver targeted advertising to prospective consumers. Accordingly, there is a need for improved systems and methods for advertisers that enable the delivery to prospective consumers of targeted advertising during traditional network programming on a television.

### SUMMARY OF THE INVENTION

It would be advantageous to achieve a set-top box that would improve upon existing limitations in functionality with respect to targeted advertising during traditional network programming on a television. It would also be desirable to enable a computer-based electronics and software solution that would provide enhanced content delivery to prospective consumers with targeted advertising. To better address one or more of these concerns, a set-top box with enhanced content and system and method for use of the same are disclosed. In one embodiment of the set-top box, a signal input, a signal output, a processor, and memory are communicatively interconnected within a busing architecture in a housing. The signal input is configured to receive a source signal which includes a stream of network programming having time slots interposed therein. The set-top box detects signaling data indicative of a designated time slot within the network programming and responsive thereto, interposes content stored at the set-top box at the designated time slot within the network programming. The set-top box then forwards the interposed content to the display via the signal output. Following the forwarding of the interposed content, the set-top box returns to receiving network programming on the signal input and forwarding the network programming to the display via the signal output. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing a set-top box having enhanced content therein according to the teachings presented herein;

FIG. 2 is a schematic diagram depicting one embodiment of the set-top box splicing enhanced content into a network program stream;

FIG. 3A is a schematic diagram depicting one embodiment of the system of FIG. 1 within a cloud-computing deployment;

FIG. 3B is a schematic diagram depicting one embodiment of the system of FIG. 1 within an on-property deployment;

FIG. 3C is a schematic diagram depicting one embodiment of the system of FIG. 1 within a cloud-computing deployment serving multiple properties;

FIG. 4A is a wall-facing exterior elevation view of one embodiment of the set-top box depicted in FIG. 1 in further detail;

FIG. 4B is a television-facing exterior elevation view of the set-top box depicted in FIG. 1;

FIG. 4C is a front perspective view of a dongle depicted in FIG. 1 in further detail;

FIG. 5 is a functional block diagram depicting one embodiment of the set-top box presented in FIGS. 3A and 3B;

FIG. 6 is a functional block diagram depicting one embodiment of a server presented in FIGS. 2A and 2B; and

FIG. 7 is a flow chart depicting one embodiment of a method for providing a set-top box having enhanced content according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

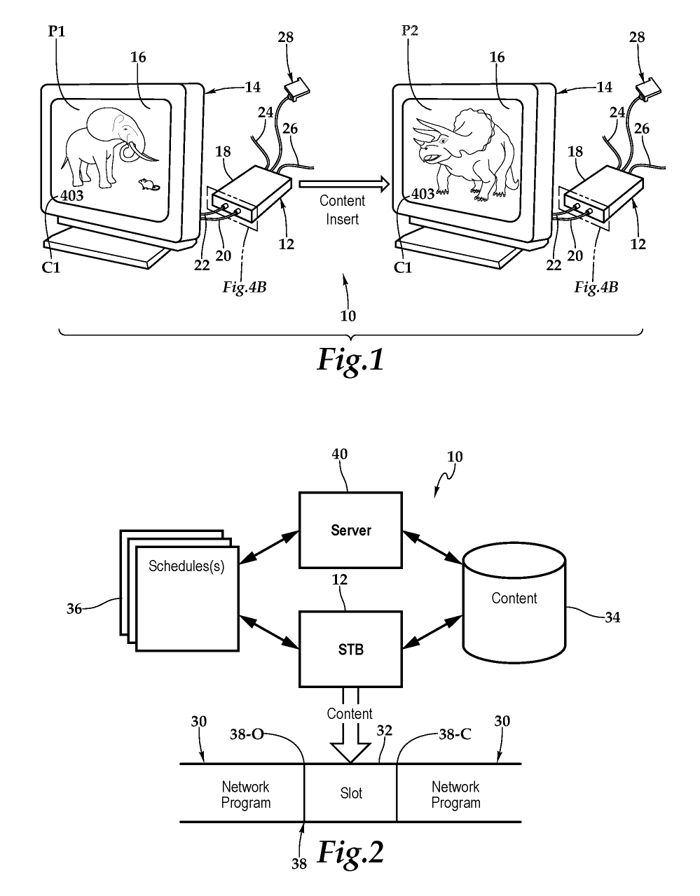

Referring initially to FIG. 1, therein is depicted one embodiment of a system for providing enhanced content, which is schematically illustrated and designated 10. As shown, the system 10 includes a set-top box 12 and a display 14, which is illustrated as a television having a screen 16. It should be appreciated however, that the display 14 may also be any electronic visual display device, for example. The set-top box 12 includes a housing 18 having a connection, which is depicted as an HDMI connection 20, that connects the set-top box 12 to the display 14. Other connections include a power cable 22 coupling the set-top box 12 to a power source, a coaxial cable 24 coupling the set-top box 12 to external cable source, and a category five (Cat 5) cable 26 coupling the set-top box 12 to an external pay-per-view source at a hotel or other lodging establishment, for example. As shown, the set-top box 12 may include a dongle 28 providing particular technology and functionality extensions thereto. That is, the set-top box 12 may be set-top box-dongle combination in one embodiment. It should be appreciated that the cabling connected to the set-top box 12 will depend on the environment and application and the cabling connections presented in figure are depicted for illustrative purposes. Further, it should appreciated that the positioning of the set-top box 12 will vary depending on environment and application and, with certain functionality, the set-top box 12 may be placed more discretely behind the display 14. By way of further example, the set-top box 12 may be in-wall mount as opposed to the illustrated free standing information appliance device.

In one implementation, the set-top box 12 is configured to receive a source signal at the coaxial cable which includes a stream of network programming having time slots interposed therein. As illustrated, channel 403, as indicated by C1, is broadcasting a program, as indicated by P1, and this program P1 is on the screen 16 of the display 14. The set-top box 12 detects signaling data indicative of a designated time slot within the network programming and responsive thereto, interposes content stored at the set-top box 12 at the designated time slot within the network programming. The set-top box 12 then forwards the interposed content to the display 14 via the signal output. As illustrated, channel 403, as indicated by C1, is broadcasting the content, as indicated by P2, and this content P2 is on the screen 16 of the display 14. Following the forwarding of the interposed content P2, the set-top box 12 returns to receiving network programming on the signal input and forwarding the network programming to the display 14 via the signal output on the HDMI connection 20.

Referring now to FIG. 2, in one embodiment, the set-top box 12 is providing network programming 30 in an environment where scheduled content time slots, such as time slot 32, are planned for content 34, such as advertising content or promotional content, according to a schedule 36. The network programming 30 may be audio media or audiovisual media and is depicted as audiovisual media to fully leverage the display 14. As shown, the network programming 30 may include splice signaling data 38 indicating the available time slot by way of opening 38-O and closing 38-C. In one implementation, the set-top box 12 receives the schedule 36 from a server 40 indicating the time when the content 34 may be inserted into an available time slot 32. Based on the schedule 36, the set-top box 12 receives content 34 and stores the received content 34 in a queue for insertion into the available time slot 32 within the network programming 30. In one implementation, the set-top box 12 actively fetches the content 34 based on the schedule 36 and in another implementation, the server 40 sends the content 34 to the set-top box 12. In another embodiment, the set-top box 12 may acquire the content 34 in real-time, when required for insertion into the network programming 30. The content 34 may be an advertisement or non-advertising content. In an embodiment relating to hospitality establishments, the content 34 may be non-advertising content related to a hospitality establishment such as a furnished multi-family residences, dormitories, lodging establishments, hotels, hospitals, and multi-unit environments. Further, the content 34 may be advertising content that is replacing advertising content within the network programming 30.

As mentioned, the network programming 30 includes splice signaling data 38 indicating the available time slot 32 by way of the opening 38-O and the closing 38-C. The splice signaling data 38 may be an audio indicator, such as a dual-tone multi-frequency signaling (DTMF), a visual indicator, or a digital indicator, for example. When the set-top box 12 detects the time slot 32 by way of the splice signaling data 38, the set-top box 12 inserts the content 34 into the stream forwarded to the display 14 and then returns to the network programming 30. It should be appreciated that the set-top box 12 audio and video decoding functions continue to decode the network programming stream and presenting video and audio to the display 14.

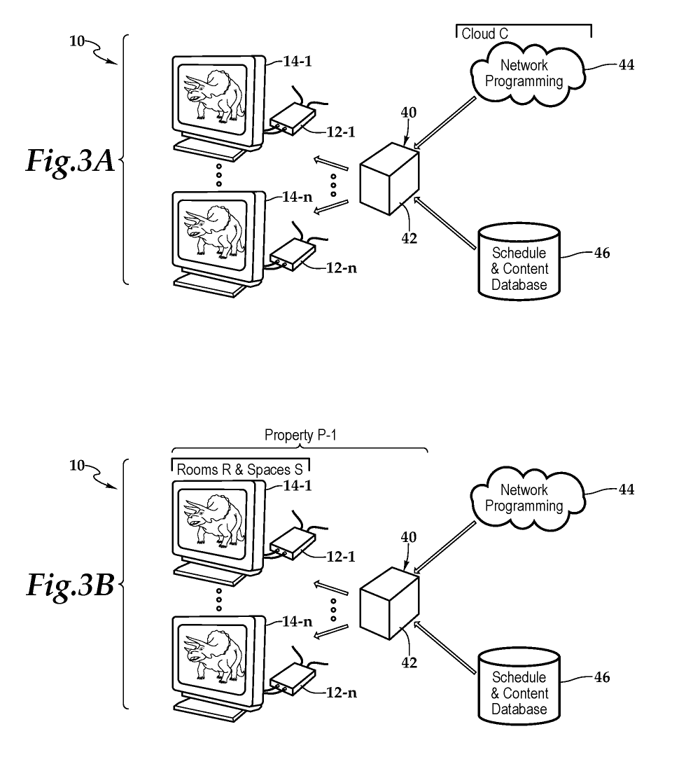

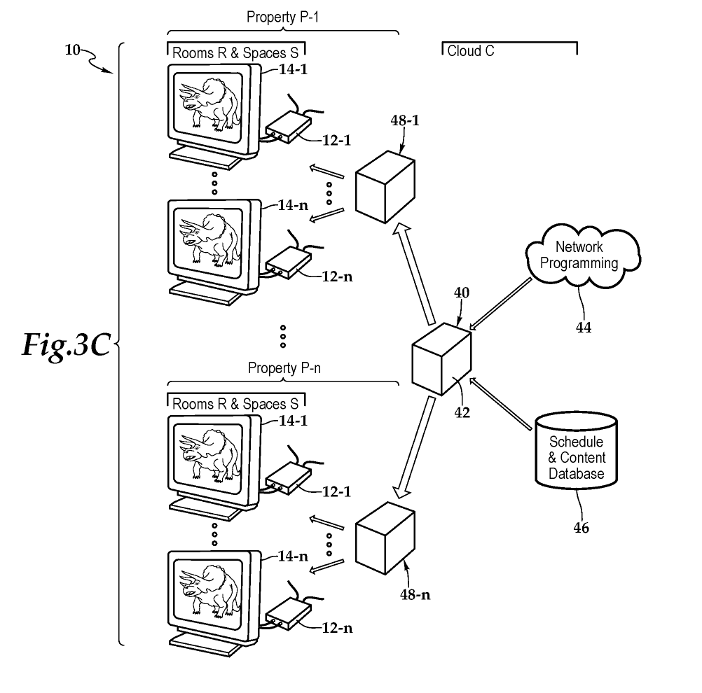

The server 40 may be remotely located to serve multiple set-top boxes and displays each located on different properties. It should also be appreciated that the server 40 may be located on a single property to serve one or more set-top boxes and displays thereon. Further, it should be appreciated that the server 40 may be remotely located to serve multiple properties having multiple televisions. Referring now to FIG. 3A, the system 10 may be deployed such that the server 40, which includes a housing 42, is remotely located in the cloud C to service disbursed set-top boxes 12-1 . . . 12-n and corresponding displays 14-1 . . . 14-n, with, in one embodiment, network programming content sources 44 configured to provide sources of network programming 30. The server 40 includes the housing 42 having a signal output and other components therein. The server 40 has access to schedule and content databases 46, which store the particular content 34 and the schedule 36. It should be appreciated that the schedule and content databases may be partially or fully integrated into the server 40.

Referring now to FIG. 3B, the system 10 may be deployed such that the server 40, which includes a housing 42, is co-located on the property P-1 with the set-top boxes 12-1 . . . 12-n and the corresponding displays 14-1 . . . 14-n, with, in one embodiment, network programming content sources 44 configured to provide sources of network programming 30. The property P-1 may have various rooms R and spaces S where the set-top boxes 12-1 . . . 12-n and the corresponding displays 14-1 . . . 14-n are displayed. The server 40 has access to the schedule 36 and content databases 46, which store the particular content 34 and the schedule 36. It should be appreciated that the schedule 36 and content databases 46 may be partially or fully integrated into the server 40.

Referring to FIG. 3C, the system 10 may be deployed such that the server 40 is located remotely within cloud C relative to set-top boxes 12-1 . . . 12-n, which are located at properties P-1 through P-n. Each property P-1 . . . P-n has various rooms R and spaces S. In particular, the server 40, which receives content from network programming content sources 44, may be located remotely relative to the set-top boxes 12-1 . . . 12-n and displays 14-1 . . . 14-n such that a property headend 48-1 . . . 48-n is interposed between the server 40 and the set-top boxes 12-1 . . . 12-n. As shown, in this implementation, the property headend 48-1 . . . 48-n is co-located with the set-top boxes 12-1 . . . 12-n at a respective property, P-1 through P-n.

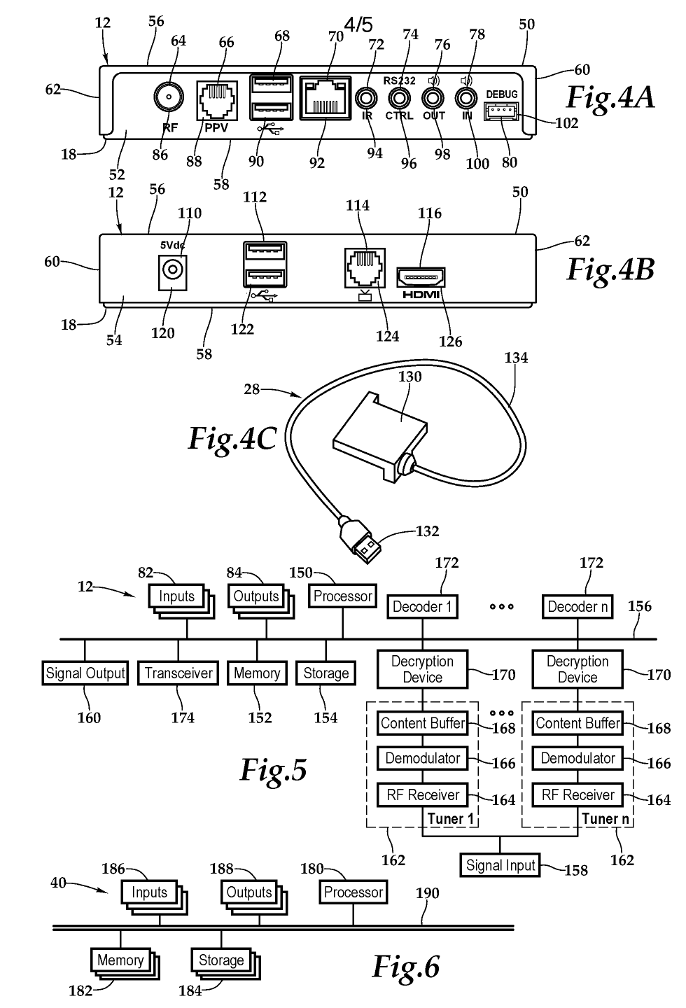

Referring to FIG. 4A, FIG. 4B, FIG. 4C, and FIG. 5, as used herein, set-top boxes, back boxes and set-top/back boxes may be discussed as set-top boxes. By way of example, the set-top box 12 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. The information appliance device may include high speed internet access point capabilities. Such set-top boxes are used in cable television, satellite television, and over-the-air television systems, for example.

The set-top box 12 includes a housing 18 with a cover 50 and a rear wall 52, front wall 54, top wall 56, bottom base 58, and two sidewalls 60, 62. It should be appreciated that front wall, rear wall, and side wall are relative terms used for descriptive purposes and the orientation and the nomenclature of the walls may vary depending on application. The front wall includes various ports, ports 64, 66, 68, 70, 72, 74, 76, 78, and 80 that provide interfaces for various interfaces, including inputs and outputs. In one implementation, as illustrated, the ports 64 through 80 include inputs 82 and outputs 84 and, more particularly, an RF input 86, a RJ-45 input 88, universal serial bus (USB) input/outputs 90, an Ethernet category 5 (Cat 5) coupling 92, an internal reset 94, an RS232 control 96, an audio out 98, an audio in 100, and a debug/maintenance port 102. The front wall 54 also includes various inputs 82 and outputs 84. More particularly, ports 110, 112, 114, and 116 include a 5V dc power connection 120, USB inputs/outputs 122, an RJ-45 coupling 124, and an HDMI port 126. It should be appreciated that the configuration of ports may vary with the set-top box 12 depending on application and context. As previously alluded to, the housing 18 may include a housing-dongle combination including, with respect to the dongle 28, a unit 130 having a cable 134 with a set-top box connector 132 for selectively coupling with the set-top box 12.

Within the housing 18, a processor 150, memory 152, storage 154, the inputs 82, and the outputs 84 are interconnected by a bus architecture 156 within a mounting architecture. It should be understood that the processor 150, memory 152, storage 154, the inputs 82, and the outputs 84 may be entirely contained within the housing 18 or the housing-dongle combination. The processor 150 may process instructions for execution within the computing device, including instructions stored in the memory 152 or in storage 154. The memory 152 stores information within the computing device. In one implementation, the memory 152 is a volatile memory unit or units. In another implementation, the memory 152 is a non-volatile memory unit or units. Storage 154 provides capacity that is capable of providing mass storage for the set-top box 12. Various inputs 82 and outputs 84 provide connections to and from the computing device, wherein the inputs 82 are the signals or data received by the set-top box 12, and the outputs 84 are the signals or data sent from the set-top box 12.

A signal input 158 and a signal output 160 are also secured in the housing 18 in order to receive content from a source, such as a hospitality property, and forward the content, including external content such as cable and satellite and pay-per-view (PPV) programming and the content 34 to the display. More specifically, the signal input 158 receives a source signal from an external source. The source signal includes multiple channels. Each tuner 162 is configured to receive and tune a channel from the source signal as well as, in one embodiment, process the received content for insertion. As shown, each tuner 162 includes an RF receiver 164, a demodulator 166, and a content buffer 168 associated with a decryption device 170 and a decoder 172 in order to provide a tuned channel. The radio frequency (RF) receiver 164 is the portion of the tuner that receives RF transmissions and converts the selected carrier frequency and its associated bandwidth into a fixed frequency that is suitable for further processing. The demodulator 166 is an electronic circuit that is used to recover the information content from the modulated carrier wave provided by the RF receiver 164. The contact buffer 168 stores the signal and may be independent storage or associated with or form a portion of the memory 152 or the storage 154. The decryption device 170 then decrypts the demodulated signal before decoding at the decoder 172. It should be appreciated that although a particular architecture of tuner, RF receiver, demodulator, decryption device and decoder is depicted, other architectures are within the teachings presented herein.

A transceiver 174 is associated with the set-top box 12 and communicatively disposed with the bus architecture 156. As shown the transceiver 174 may be internal, external, or a combination thereof to the housing. Further, the transceiver 174 may be a transmitter/receiver, receiver, or an antenna for example. Communication between various amenities in a room with the set-top box 12 and the set-top box 12 may be enabled by a variety of wireless methodologies employed by the transceiver 174, including 802.11, 3G, 4G, Edge, WiFi, ZigBee, near field communications (NFC), Bluetooth low energy and Bluetooth, for example. Also, infrared (IR) may be utilized.

The memory 152 and storage 154 are accessible to the processor 150 and include processor-executable instructions that, when executed, cause the processor 150 to execute a series of operations. The processor-executable instructions cause the processor to receive a schedule from a server. As previously discussed, the schedule 36 may include a listing of the time slots 32. The processor-executable instructions then cause the processor 150 to store the schedule 36 at the set-top box 12. According to the schedule 36, the processor 150 is caused to receive content relative to a designated time slot 32 from the server 40 and store the content 34 at the set-top box 12. The processor-executable instructions then cause the processor 150 to receive network programming on the signal input and forward the network programming to the display 14 via the signal output 160. By way of the processor-executable instructions, the processor 150 may detect signaling data indicative of the designated time slot 32 within the network programming, and interpose, by way of splicing, for example, the content 34 at the designated time slot 32 within the network programming and forward the interposed content to the display 14 via the signal output 160. Following the forwarding of the interposed content, the set-top box 12 returns to receiving network programming on the signal input 158 and forwarding the network programming to the display 14 via the signal output 160.

Referring now to FIG. 6, one embodiment of the server 40 as a computing device includes a processor 180, memory 182, storage 184, inputs 186, and outputs 188 interconnected with various buses 190 in a common or distributed, for example, mounting architecture. In other implementations, in the computing device, multiple processors and/or multiple buses may be used, as appropriate, along with multiple memories and types of memory. Further still, in other implementations, multiple computing devices may be provided and operations distributed therebetween. The processor 180 may process instructions for execution within the server 40, including instructions stored in the memory 182 or in storage 184. The memory 182 stores information within the computing device. In one implementation, the memory 182 is a volatile memory unit or units. In another implementation, the memory 182 is a non-volatile memory unit or units. Storage 184 includes capacity that is capable of providing mass storage for the server 40. Various inputs 186 and outputs 188 provide connections to and from the server 40, wherein the inputs 186 are the signals or data received by the server 40, and the outputs 188 are the signals or data sent from the server 40.

The memory 182 is accessible to the processor 180 and includes processor-executable instructions that, when executed, cause the processor 180 to execute a series of operations. The processor-executable instructions cause the processor to update periodically or on-demand, depending on the operational configuration, a database which may be part of storage 184 of schedules of time slots on various channels of network programming and related content or update portion thereof, with current timeslot scheduling and content information. The processor-executable instructions cause the processor 180 to make this database or a portion thereof available to the set-top boxes 12 by way of the set-top boxes 12 receiving the information through fetching or the server 40 sending the requested information. Thus, the systems and methods disclosed herein enable set-top boxes to have enhanced content offerings. Further, the systems and methods disclosed herein may enable advertisers to use set-top boxes as a solution to provide to prospective consumers targeted advertising, during network programming, for example.

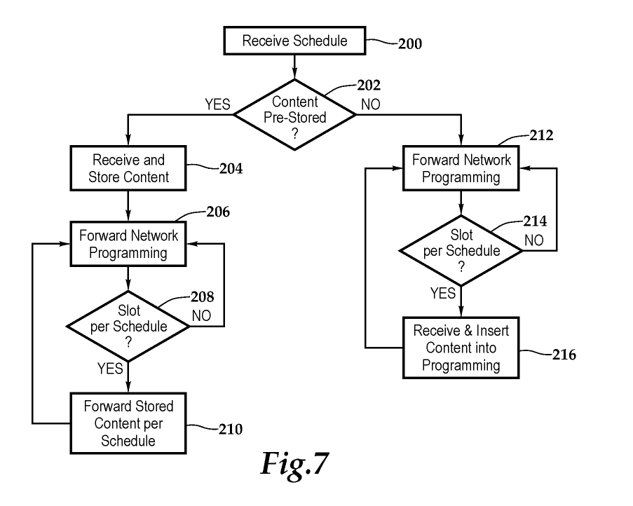

FIG. 7 depicts one embodiment of a method for providing enhanced content, according to the teachings presented herein. The methodology starts at block 200 when the set-top box receives a schedule of the available time slots. In one embodiment, the schedule may also include the particular content to be displayed for each time slot. At decision block 202, if the content is pre-stored at the set-top box, then the methodology advances to block 204, where content that will be utilized within a certain period of time is received and stored at the set-top box. At block 206, network programming is received at the set-top box and forwarded to the display. At decision block 208, if the scheduled time slot has not been detected, then the methodology returns to block 206 and continues in a loop between decision block 208 and block 206 until the scheduled time slot is detected by way of signaling data. At block 210, the stored content is forwarded to the display in the stream of the network programming prior to the network programming continuing at block 206.

Returning to decision block 202, if the content is not pre-stored, then in one implementation, the methodology advances to block 212 where network programming is received at the set-top box and forwarded to the display. At decision block 214, if the scheduled time slot has not been detected, then the methodology returns to block 212 and continues in a loop between decision block 214 and block 212 until the scheduled time slot is detected by way of signaling data. At block 216, the content to be inserted into the network programming, by way of splicing, for example, is forwarded to the display in the stream of the network programming prior to the network programming continuing at block 212.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A set-top box comprising:
a housing securing a television input, a television output, a processor, memory, and storage therein;
a busing architecture communicatively interconnecting the signal input, the signal output, the processor, the memory, and the storage;
the signal input configured to receive a source signal from an external source, the source signal including a stream of network programming having a plurality of time slots interposed therein;
the signal output configured to forward a fully tuned signal to a display; and
the memory accessible to the processor, the memory including processor-executable instructions that, when executed, cause the processor to:
receive a schedule from a server, the schedule including a listing of the plurality of time slots,
store the schedule at the set-top box,
receive content relative to a designated time slot from the server according to the schedule,
store the content at the set-top box,
receive network programming on the signal input and forward the network programming to the display via the signal output,
detect signaling data indicative of the designated time slot within the network programming,
interpose the content at the designated time slot within the network programming and forward the interposed content to the display via the signal output, and
following the forwarding of the interposed content, receive network programming on the signal input and forward the network programming to the display via the signal output.

2. The set-top box as recited in claim 1, wherein the content further comprises an advertisement.

3. The set-top box as recited in claim 1, wherein the content further comprises a first advertisement substituting for a second advertisement within the network programming.

4. The set-top box as recited in claim 1, wherein the content further comprises non-advertising content.

5. The set-top box as recited in claim 1, wherein the content further comprises non-advertising content relating to a hospitality establishment.

6. The set-top box as recited in claim 5, wherein the hospitality establishment is selected from the group consisting of furnished multi-family residences, dormitories, lodging establishments, hotels, hospitals, and multi-unit environments.

7. The set-top box as recited in claim 1, wherein the plurality of time slots further comprise a plurality of local advertising time slots.

8. The set-top box as recited in claim 1, wherein the processor-executable instructions further comprise instructions that, when executed, cause the processor to fetch content relative to a designated time slot from the server according to the schedule.

9. The set-top box as recited in claim 1, wherein the processor-executable instructions further comprise instructions that, when executed, cause the processor to receive content sent from the server relative to a designated time slot from the server according to the schedule.

10. The set-top box as recited in claim 1, wherein the signaling data further comprises an audio indicator.

11. The set-top box as recited in claim 1, wherein the signaling data further comprises a visual indicator.

12. The set-top box as recited in claim 1, wherein the signaling data further comprises a digital indicator.

13. The set-top box as recited in claim 1, wherein the schedule further comprises the time of each of the plurality of time slots and identification of particular content associated with each of the plurality of time slots.

14. The set-top box as recited in claim 1, wherein the processor-executable instructions further comprise instructions that, when executed, cause the processor to interpose, by way of splicing, the content at the designated time slot within the network programming and forward the interposed content to the display via the signal output.

15. The set-top box as recited in claim 1, wherein the network programming further comprises media selected from the group consisting of audio media and audiovisual media.

16. The set-top box as recited in claim 1, wherein the display further comprises a device selected from the group consisting of electronic visual display devices and televisions.

17. The set-top box as recited in claim 1, wherein the housing further comprises a housing-dongle combination securing the television input, the television output, the processor, memory, storage, and wireless transceiver therewith.

18. The set-top box as recited in claim 12, wherein the processor and the memory are distributed through the housing-dongle combination.

19. A set-top box comprising:
a housing securing a television input, a television output, a processor, memory, and storage therein;
a busing architecture communicatively interconnecting the signal input, the signal output, the processor, the memory, and the storage;
the signal input configured to receive a source signal from an external source, the source signal including a stream of network programming having a plurality of time slots interposed therein;
the signal output configured to forward a fully tuned signal to a display; and
the memory accessible to the processor, the memory including processor-executable instructions that, when executed, cause the processor to:
receive network programming on the signal input and forward the network programming to the display via the signal output,
detect signaling data indicative of the designated time slot within the network programming,
access content stored at the set-top box,
interpose the content at the designated time slot within the network programming and forward the interposed content to the display via the signal output, and
following the forwarding of the interposed content, receive network programming on the signal input and forward the network programming to the display via the signal output.

20. A set-top box comprising:
a housing securing a television input, a television output, a processor, memory, and storage therein;
a busing architecture communicatively interconnecting the signal input, the signal output, the processor, the memory, and the storage;
the signal input configured to receive a source signal from an external source, the source signal including a stream of network programming having a plurality of time slots interposed therein, the plurality of time slots indicating a respective plurality of advertisements within the network programming;
the signal output configured to forward a fully tuned signal to a display; and
the memory accessible to the processor, the memory including processor-executable instructions that, when executed, cause the processor to:
receive a schedule from a server, the schedule including a listing of the plurality of time slots,
store the schedule at the set-top box,
receive content relative to a designated time slot from the server according to the schedule,
store the content at the set-top box,
receive network programming on the signal input and forward the network programming to the display via the signal output,
detect signaling data indicative of the designated time slot within the network programming,
interpose, by way of splicing, the content at the designated time slot within the network programming and forward the interposed content to the display via the signal output, and
following the forwarding of the interposed content, receive network programming on the signal input and forward the network programming to the display via the signal output.
